(19) United States
(12) Patent Application Publication
(10) Pub. No.: US 2005/0019080 A1
(43) Pub. Date: Jan. 27, 2005

(54) Color encoded keyboard and method

(76) Inventor: Mark Pearson, Annapolis, MD (US)

Correspondence Address: LAW OFFICE OF LAWRENCE E LAUBSCHER, JR, 1160 SPA RD, SUITE 2B, ANNAPOLIS, MD, 21403, US

(21) Appl. No.: 10/626,801

(22) Filed: Jul. 23, 2003

(51) Int. Cl. B41J 5/08; H01H 9/00; G09G 5/00

(52) U.S. Cl. 400/490; 400/495; 200/309; 345/168; 345/172

(57) ABSTRACT

A computer keyboard optimized for generating multi-color text documents is described. A standard keyboard includes a plurality of selected function keys that have been programmed to change the document text color when activated. Each of the selected keys further includes color indicia to indicate the new text color that results from activation of that key. Without removing the user's hands from the keyboard, a user may produce text color changes while typing a document with no more effort than capitalizing text.

### BACKGROUND OF THE INVENTION

The present invention relates to the field of computer keyboards, and more particularly to keyboards for which selected keys are programmed to effect text color changes and color encoded to indicate the resulting text color.

Most computer-generated documents have previously been printed with black text on white paper. When color was used in printed documents, it was common to minimize the number of colors used and the number of color changes due to the relative inconvenience initiating text color changes. Even with the widespread availability of color printers, many documents such as letters, reports, and memos continue to be generated primarily in black and white despite a growing appreciation of the enhanced impact that multi-color documents can provide. A reason why computers users do not more freely utilize changes in text color to increase the visual impact of their correspondence and other documents is that most application software requires an inconvenient and relatively slow process to effect text color changes. A mouse may be used to manipulate icons on a function bar, but this requires removal of the hand from the keyboard. Effecting text color changes from the keyboard often requires a hard to remember and complicated multi-step series of keyboard strokes. Alternatively, the number of key strokes required to effect a text color change may be reduced by creating a programmed macro. If more than one or two text colors are so programmed, however, it becomes difficult to memorize the correspondence between the key combination that causes a particular color change and the desired color.

### BRIEF DESCRIPTION OF THE PRIOR ART

Each key of a computer keyboard normally has indicia printed on it to indicate a function that is performed by pressing that key. For example, on the conventional QWERTY keyboard, the letter “Q” printed on the key indicates that pressing that key will cause the letter “q” or “Q” to be inserted into a text document depending upon whether the SHIFT key is simultaneously pressed.

Computers usually permit some or all keys to be reprogrammed to perform multi-step functions as well as simply changing the output character, such programming generally referred to as creating a macro. For example, a command such as CTRL-B might cause the output text to appear in bold type. An obvious problem with such “altered” keyboards is that there is nothing on the face of the original key to indicate the new function.

The prior art reveals efforts to resolve some of the above problems with the use of substitute key caps and key cap overlays. U.S. Pat. No. 4,755,072 to Hoornweg discloses that temporary key caps having different indicia can be placed over the original cap to indicate an altered function or, alternatively, to mask the function if an opaque cap having no indicia is used. It also discloses the use of a colored key cap to distinguish a subset of keys while maintaining the original key function. While suggesting that colored key caps may ease association between color and function, Hoornweg does not provide any teaching of how this might be done.

There is a need for a method and apparatus that permits the use of a control or function key having color coding corresponding to the text color change that results from activation of the control key.

### SUMMARY OF THE INVENTION

The present invention provides a method and apparatus to accurately and efficiently alter the text color while typing a document. Selected function keys are programmed to change the text color in a document to be typed when the function key is activated. By programming a selected subset of text colors from the set of all colors available within the software application, the user predetermines a subset of text colors desired for use within a document to be created. Each function key is also provided with unique color indicia to visually indicate to a user the text color change that results from activation of the function key.

It is an object of the present invention to efficiently change the text color in computer-generated text documents.

It is a further object to provide a visual correspondence between a key that effects a text color change and the color of the resulting text.

A method of color encoding a computer keyboard having these and other advantages includes selecting, from the set of possible text colors provided by a computer, a subset of text colors for use in documents to be generated from the keyboard. Selected function keys are programmed to generate the selected text colors, with each selected function key generating a different selected text color. Each selected function key is provided with a color indicia to display the programmed text color of that key.

A computer keyboard optimized for generating multi-colored text documents having these and other advantages includes a selected group of programmable function keys that have been programmed to change the text color in a document when activated. Each of the selected keys is programmed to provide a selected text color, and is provided with color indicia to display the text color generated by the activation of that function key.

### BRIEF DESCRIPTION OF THE DRAWINGS

Other objects and advantages of the invention will become apparent from a study of the following specification when viewed in light of the accompanying drawings, in which:

FIG. 1 illustrates a computer keyboard to which color indicia has been applied to certain function keys in accordance with one embodiment of the invention.

FIG. 2 is an enlarged and more detailed view of a segment of the sheet of colored decals of FIG. 3.

FIG. 3 illustrates a sheet of colored decals and identifying information in accordance with one embodiment of the invention.

FIG. 4 illustrates a prior art colored key cap suitable for color encoding a computer keyboard in accordance with one embodiment of the invention.

FIG. 5 is a flow chart indicating the steps of an embodiment of the invention.

### DETAILED DESCRIPTION OF THE INVENTION

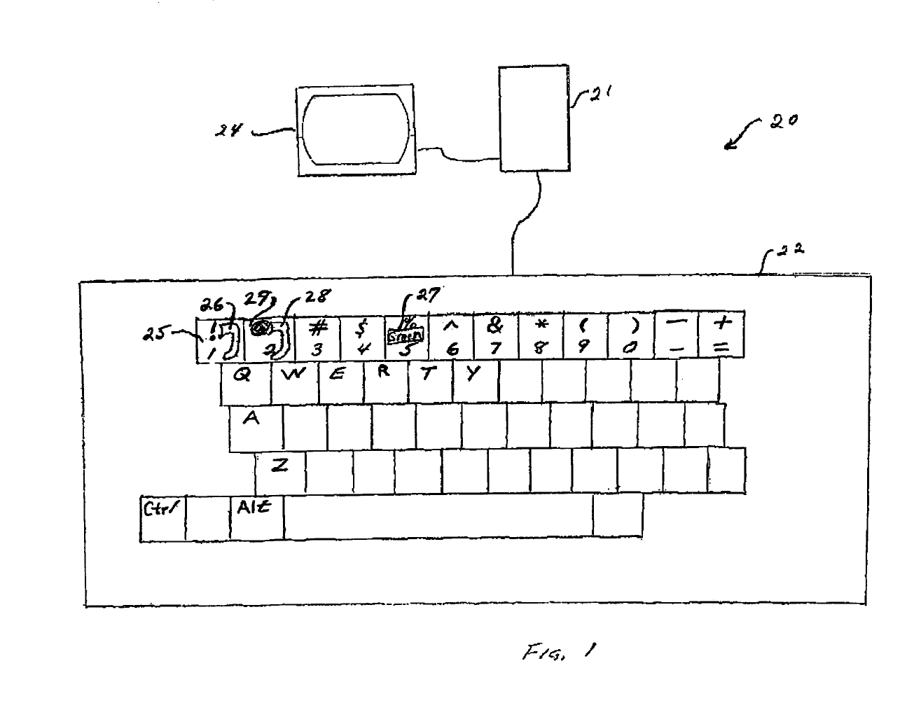

Referring to FIG. 1, a computer 20 includes a console 21 connected to a keyboard 22 and a display 24. A key 25, which in this embodiment has been chosen to be the key marked with the numeral “1”, has been provided with a decal 26. Decal 26 will preferably be colored. Alternatively, a decal 27 may have a name of a color printed thereon. A decal 28 is similarly affixed to another key 29, which in this embodiment has been chosen to be the key marked with the numeral “2”. Decal 28 is also preferably colored, but having a different color than that of decal 26. Alternatively decal 28 may have a name of a second color printed thereon similar to decal 27. Additional keys, for example the keys marked with numerals “1” through “0” and symbols “−” and “=,” may also have decals affixed, each additional decal being a different color or displaying the name of a different color. The bottom of the decals preferably has a paste-on, or adhesive, material that secures the decal to the function key during normal use but that permits the decal to be removed and replaced when a new text color is programmed into the function key.

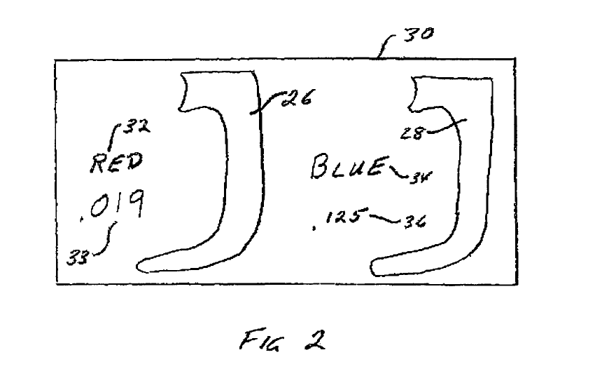

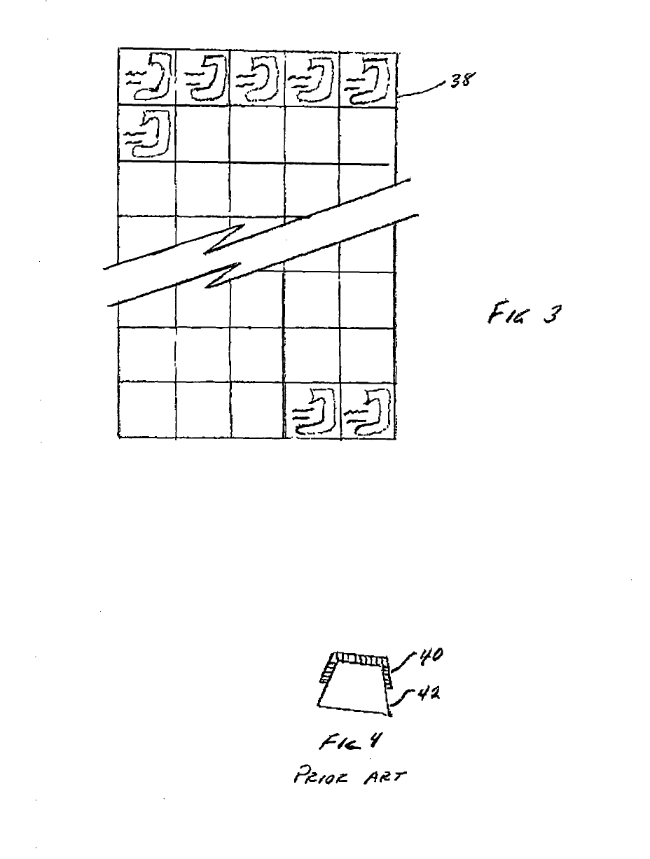

FIG. 2 illustrates a backing material 30 containing the colored decal 26 before it has been attached to key 25. In this embodiment, it is assumed that the color of decal 26 is red. Backing material 30 also has a decal 32 bearing the name of the color of decal 26 and optionally, a code number 33 to distinguish the red on this decal from another available color, such as a different shade of red. Decal 26 is sized to be affixed to a key, such as key 25, without covering the numeral “1” or the symbol “!” that is normally printed on the key. The colored decal 28, which in this embodiment is assumed to be blue, is similarly provided on backing 30 with a corresponding name 34 and code number 36. FIG. 3 illustrates a backing sheet 38 on which are supplied a number of decals with corresponding color names and code numbers from which a user can select the colors that are to be affixed to selected keys. The number and colors of decals on sheet 38 are a representative subset of the diversity of available text colors offered by the application software and will preferably exceed the number desired by a user for a given document or series of documents. For example, the total number of decals provided may be 256, out of which the user may select 12 for attachment to the “1”−“0”, “−” and “=” keys. A greater or lesser number of decals may be utilized at the election of the user according to personal preference, and the decals may be provided on one, two, or more sheets.

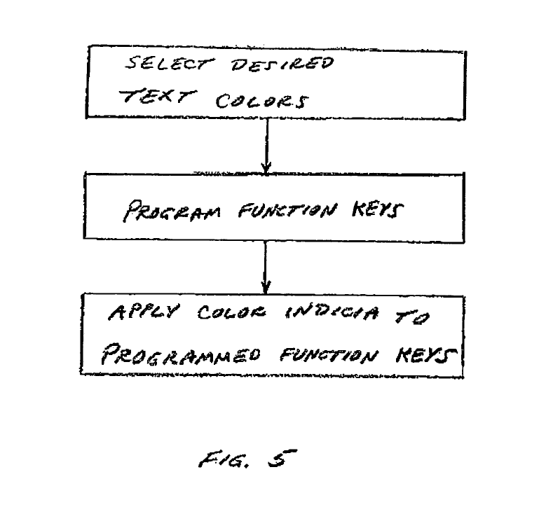

FIG. 4 illustrates a colored key cap 40 removably fitted over a key 42. Colored key caps designed to be removably fitted over a key are well known in the prior art and will not be further described here. When the colors of the key caps are provided to correspond with the text colors desired by a user, however, the caps may be utilized in place of decals or color names in an alternative embodiment of the present invention. For example, a red key cap may be fitted over the key 25 marked with the numeral “1” instead of affixing the red decal 26. The number and colors of key caps provided will preferably correspond to the diversity of available text colors offered by the application software and will preferably exceed the number desired by a user for a given document or series of documents. For example, the total number of colored key caps provided may be 256, out of which the user may select 12 for attachment to the “1”−“0,” “−” and “=” keys. A greater or lesser number of colored key caps may be utilized at the election of the user according to personal preference. Alternatively, the original keys provided with the keyboard may be physically removed and replaced with colored keys.

To use the invention, a user selects a subset of desired text colors from the set of colors provided by an application. The application may be a commercially available word processing application such as Microsoft Word or Corel WordPerfect, each of which provides 256 choices of possible text colors. Each application provides a capability for viewing the array of available colors and selecting them with the aid of the cursor.

After choosing a subset of colors, for example twelve colors from the possible 256, the user next selects twelve function keys to be programmed. For example, the user may select the keys “1” through “0” plus “−” and “=.” The user next chooses a command instruction to cause the text color change, such as “CTRL-1,” “CTRL-2,” . . . “CTRL-=.” That is, a text change would result when the user depressed the “1” key while simultaneously depressing the “CTRL” key. Preferably, the command instruction will be chosen from among those not already preprogrammed into the application software by the manufacturer.

It is well within the ordinary skills of a computer programmer to develop an application that prompts the user to select a function key and an associated text color, and then programs the keyboard to effect the appropriate text color change upon activation of a given function key. Alternatively, the user may perform the programming for each function key in the form of a macro and assign the macro to the function key as a shortcut. The program may also provide for the selection of available colors from a drop-down screen showing the array of available colors. Selection of a specific text color may be made with the aid of the cursor.

The user then provides each programmed function key with indicia to indicate the color change that results from activating that key, as was previously described.

The method described above is illustrated in FIG. 5. It is readily apparent that, after the desired text color for each function key has been selected, it makes no difference whether the programming of the function keys occurs before or after the application of the color indicia.

While the preferred forms and embodiments of the invention have been illustrated and described, it will be apparent to those of ordinary skill in the art that various changes and modifications may be made without deviating from the inventive concepts set forth above. For example, the above embodiments describe keys along the top of a standard keyboard as suitable for use as function keys. Other keys such as the number keys on the right hand side of the standard keyboard, however, would serve equally well.

1. A method of color encoding a computer keyboard, comprising the steps of:
(a) selecting, from the set of possible text colors provided by a computer, a subset of text colors for use in documents to be generated from the keyboard;
(b) programming selected function keys to generate the selected text colors, each selected function key generating a different selected text color; and
(c) color marking each selected function key with a color indicia indicative of the programmed text color of that key

2. The method of claim 1 wherein color marking each selected function key further comprises color marking each selected function key with a paste-on decal representing the programmed text color.

3. The method of claim 1 wherein color marking each selected function key further comprises replacing the key cap with another cap having the programming text color.

4. The method of claim 1 wherein color marking each selected function key further comprises overlaying the key with a fitted key cap having the programmed text color.

5. The method of claim 1 wherein programming further comprises programming the twelve keys including the numbers “1” through “0” and “−” and “=”.

6. The method of claim 2, and further comprising the further step of selecting a paste-on decal representing the programmed text color from a preprinted sheet of decals having a subset of the possible set of colors provided by the computer.

7. The method of claim 1 wherein the step of selecting a subset of text colors further includes selecting colors from a drop-down screen.

8. A computer keyboard optimized for generating multi-colored text documents, comprising:
(a) a plurality of programmable function keys that have been programmed to change the text color in a document when activated, each of said plurality of keys programmed to a selected color; and
(b) color indicia on each function key indicative of the text color generated by the activation of that function key.

9. The keyboard of claim 8 wherein the color indicia is a decal colored to represent the text color generated by the activation of the function key.

10. The keyboard of claim 8 wherein the color indicia is a replacement key colored to represent the text color generated by the activation of the function key.

11. The keyboard of claim 8 wherein the color indicia is a key cap colored to represent the text color generated by the activation of the function key.
